(19) United States
(12) Patent Application Publication
(10) Pub. No.: US 2024/0036701 A1
(43) Pub. Date: Feb. 1, 2024

(54) A COMPUTER A SOFTWARE MODULE ARRANGEMENT, A CIRCUITRY ARRANGEMENT, A USER EQUIPMENT AND A METHOD FOR AN IMPROVED AND EXTENDED USER INTERFACE

(71) Applicant: Telefonaktiebolaget LM Ericsson (publ), Stockholm (SE)

(72) Inventors: Andreas Kristensson, SÖDRA SANDBY (SE); Alexander Hunt, TYGELSJÖ (SE); Fredrik Dahlgren, LUND (SE)

(21) Appl. No.: 18/275,820

(22) PCT Filed: Mar. 3, 2021
(86) PCT No.: PCT/EP2021/055344

§ 371 Date: Aug. 4, 2023

(51) Int. Cl. G06F 3/04817; G06F 3/04845; G06F 3/0488; G06F 3/042

(52) U.S. Cl. CPC G06F 3/04817; G06F 3/04845; G06F 3/0488; G06F 3/042

(57) ABSTRACT

A user equipment comprising a display, at least one side sensor and a controller, wherein the side sensor is configured to receive touchless user input at a side of the display, thereby providing a touchless input area, and wherein the controller is configured to: receive a selection of an application; receive a selection of a portion of the touchless input area; associate at least one command for the selected application to the selected portion of the touchless input area; provide feedback indication the association between the portion and the application; determine that an object is at a distance falling under a threshold distance in the selected portion of the touchless input area and in response thereto execute the associated command.

### TECHNICAL FIELD

The present invention relates to an arrangement, an arrangement comprising computer a software modules, an arrangement comprising circuits, a user equipment and a method for providing an improved and extended user interface, and in particular to an arrangement, an arrangement comprising computer a software modules, an arrangement comprising circuits, a user equipment and a method for providing an improved and extended user interface enabling controlling of background applications.

### BACKGROUND

Today's user equipments or mobile devices have touchscreens. These are based on touching the display with one or several fingers, and moving the finger in a certain way can have certain specific meaning, such as touching the screen and moving the finger from the bottom of the screen and upwards on a device such as an iPhone means that the active applications are listed as windows-based icons in the screen that one can as a next step scroll between.

There are sensors added to such mobile devices, e.g. radar that enable gesture recognition or detection of movements in certain parts of the space surrounding the device.

In many applications or navigation scenarios, the touch input is limited by the size of the device display, e.g. scrolling through content that in itself is not related to size of the device display. For example, a smartwatch has a very limited physical size of the display.

In many usage scenarios and for many mobile device applications, the application takes over the complete screen when active, meaning that the area on the touchscreen to potentially control other applications are no longer available, and to be able to control other applications often implies a multi-touch sequence to move to the other application where the current shown application needs to be changed and another application should be selected to be shown on the screen.

There are technologies to identify gestures or movements outside of physical device, e.g. by radar or camera, but these normally are less intuitive from a usage perspective.

### SUMMARY

As discussed above, the inventors have realized that as the touchless input area is invisible and as the touchless input area is designed to be used when another application is being active, i.e. takes up most of the display space, it is inherently difficult for a user to realize what controls have which effect. The solution according to the teachings herein enable a user to correlate functions to applications and portions of the touchless input area. Moreover, the solutions provided are simple and elegant, which is inventive in itself.

The invention is based on the combination of selecting and placing user equipment and/or application user interface controls in the nearby space surrounding the user equipment, and have said controls visually indicated by said user equipment and/or application control on the user equipment display, to make it easy and natural for the user to interact with selected control in the space surrounding the user equipment.

An object of the present teachings is thus to overcome or at least reduce or mitigate the problems discussed in the above.

According to one aspect a user equipment comprising a display, at least one side sensor and a controller, wherein the side sensor is configured to receive touchless user input at a side of the display, thereby providing a touchless input area, and wherein the controller is configured to: receive a selection of an application; receive a selection of a portion of the touchless input area; associate at least one command for the selected application to the selected portion of the touchless input area; provide feedback indication the association between the portion and the application; determine that an object (F) is at a distance (D) falling under a threshold distance in the selected portion of the touchless input area and in response thereto execute the associated command.

It should be noted that in one embodiment the application is a user equipment specific application representing a functionality of the user equipment, i.e. a function of the user equipment. It should be noted that in one alternative or additional embodiment the application is an application to be executed and operated in the user equipment, i.e. a normal application.

This allows for a much larger interaction area than limited by the physical size of the display, at the same time as the risk of mistaking hand movements next to the phone as input control is minimized. The resulting user interface will be intuitive, so that the extended touch area, i.e. the touchless input area is activated and used as a very natural extension to the physical touchscreen. User equipment and/or application user interface controls defined to be placed in the touchless input area surrounding the user equipment will be clearly indicated by the user equipment on the user equipment display.

In one embodiment the controller is further configured to receive the selection of the application by receiving a selection of a graphical representation of the application.

In one embodiment the controller is further configured to receive the selection of a portion of the touchless input area by determining that the selected application is dragged to a portion of the display corresponding to the portion of the touchless input area.

In one embodiment the portion of the touchless input area corresponds to a side of the display.

In one embodiment the portion of the touchless input area corresponds to a portion of a side of the display.

In one embodiment a plurality of commands is associated to the portion, each command being associated to each a subportion.

In one embodiment the controller is further configured to indicate at least one portion available for association with an application.

In one embodiment the controller is further configured to determine that the selected portion is associated with another application and in response thereto re-associate the other application with another portion.

In one embodiment the controller is further configured to determine that the selected portion is associated with another application and in response thereto divide the selected portion into at least two subportions and re-associate the other application with one of the subportions of the selected portion as well as associate the other subportion of the selected portion with the selected application.

In one embodiment the the controller is further configured to determine that a hold of the user equipment has been changed and in response there to re-associate the application to another portion.

In one embodiment the selected application is a background application.

In one embodiment the user equipment is a smartphone, smart watch or a tablet computer.

According to one aspect there is provided a method for use in a user equipment comprising a display and at least one side sensor configured to receive touchless user input at a side of the display, thereby providing a touchless input area, and wherein the method comprises: receiving a selection of an application; receiving a selection of a portion of the touchless input area; associating at least one command for the selected application to the selected portion of the touchless input area; providing feedback indication the association between the portion and the application; determining that an object (F) is at a distance (D) falling under a threshold distance in the selected portion of the touchless input area and in response thereto executing the associated command.

According to one aspect there is provided a software module arrangement for a user equipment comprising a display and at least one side sensor configured to receive touchless user input at a side of the display, thereby providing a touchless input area, wherein the a software module arrangement comprises: a software module for receiving a selection of an application; a software module for receiving a selection of a portion of the touchless input area; a software module for associating at least one command for the selected application to the selected portion of the touchless input area; a software module for providing feedback indication the association between the portion and the application; a software module for determining that an object (F) is at a distance (D) falling under a threshold distance in the selected portion of the touchless input area and a software module for executing the associated command in response thereto.

According to one aspect there is provided an arrangement adapted to be used in a user equipment comprising a display, at least one side sensor configured to receive touchless user input at a side of the display, thereby providing a touchless input area, and said arrangement comprising: circuitry for receiving a selection of an application; circuitry for receiving a selection of a portion of the touchless input area; circuitry for associating at least one command for the selected application to the selected portion of the touchless input area; circuitry for providing feedback indication the association between the portion and the application; circuitry for determining that an object (F) is at a distance (D) falling under a threshold distance in the selected portion of the touchless input area and circuitry for executing the associated command in response thereto.

According to one aspect there is provided a computer-readable medium carrying computer instructions that when loaded into and executed by a controller of a user equipment enables the user equipment to implement any of the methods herein.

The solution may be implemented as a software solution, a hardware solution or a mix of software and hardware components. Further embodiments and advantages of the present invention will be given in the detailed description. It should be noted that the teachings herein find use in digital imagery arrangements in digital photography as well as many areas of computer vision, including image retrieval, robotic vision, augmented reality and video surveillance.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a user equipment according to an embodiment of the present invention;

FIG. 1B shows a schematic view of a subsection of a user equipment according to an embodiment of the present invention;

FIG. 1C shows the user equipment of FIG. 1A, where different commands have been assigned to different portions of the touchless input area of the user equipment according to an embodiment of the present invention;

FIG. 2A shows a schematic view of a user equipment according to an embodiment of the present invention;

FIG. 2B shows a schematic view of a user equipment according to an embodiment of the present invention;

FIG. 2C shows a schematic view of a user equipment according to an embodiment of the present invention;

FIG. 2D shows a schematic view of a user equipment according to an embodiment of the present invention;

FIG. 2E shows a schematic view of a user equipment according to an embodiment of the present invention;

FIG. 2F shows a schematic view of a user equipment according to an embodiment of the present invention;

FIG. 3A shows a schematic view of a user equipment according to an embodiment of the present invention;

FIG. 3B shows a schematic view of a user equipment according to an embodiment of the present invention;

FIG. 3C shows a schematic view of a user equipment according to an embodiment of the present invention;

FIG. 4A shows a schematic view of a user equipment according to an embodiment of the present invention;

FIG. 4B shows a schematic view of a user equipment according to an embodiment of the present invention;

FIG. 5A shows a schematic view of a user equipment according to an embodiment of the present invention;

FIG. 5B shows a schematic view of a user equipment according to an embodiment of the present invention;

FIG. 6 shows a flowchart of a general method according to an embodiment of the present invention;

FIG. 7 shows a component view for a software module arrangement according to an embodiment of the teachings herein;

FIG. 8 shows a component view for an arrangement comprising circuits according to an embodiment of the teachings herein; and

FIG. 9 shows a schematic view of a computer-readable medium carrying computer instructions that when loaded into and executed by a controller of an arrangement enables the arrangement to implement an embodiment of the present invention.

### DETAILED DESCRIPTION

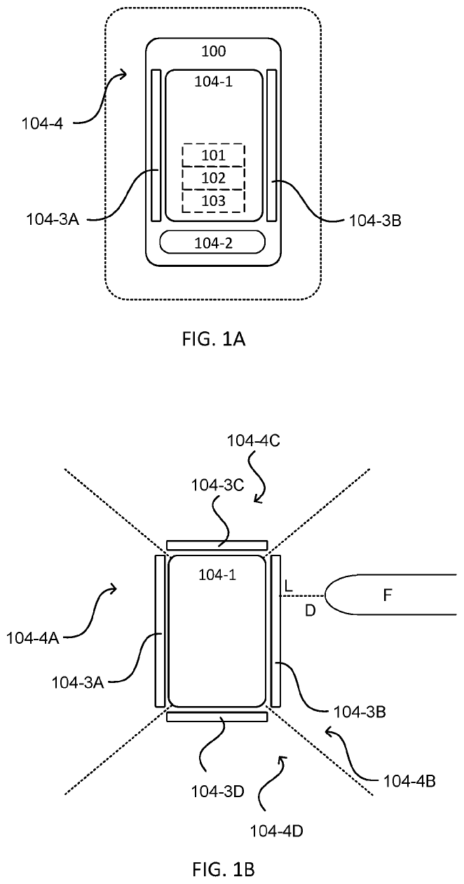

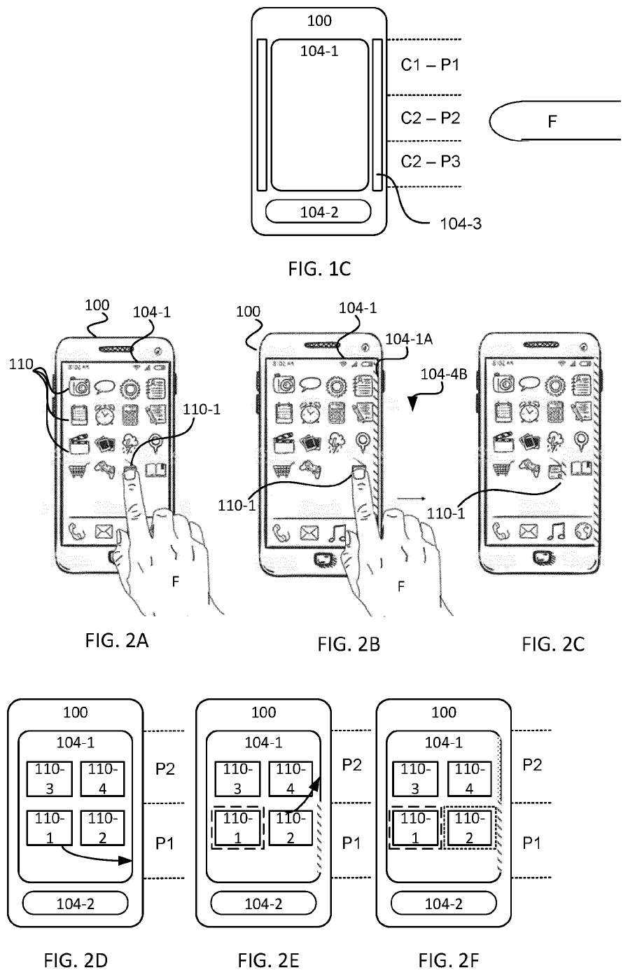

FIG. 1A shows a schematic view of a user equipment 100 according to an embodiment of the present invention. In one example embodiment, the user equipment 100 is a smartphone, smartwatch or a tablet computer. The user equipment 100 comprises a controller 101 a memory 102 and a user interface 104 comprising one or more interface components (104-1-104-4 as will be described in more detail below).

It should be noted that the user equipment 100 may comprise a single device or may be distributed across several devices and apparatuses.

The controller 101 is configured to control the overall operation of the user equipment 100. In one embodiment, the controller 101 is a specific purpose controller. In one embodiment, the controller 101 is a general purpose controller. In one embodiment, the controller 101 is a combination of one or more of a specific purpose controller and/or a general purpose controller. As a skilled person would understand there are many alternatives for how to implement a controller, such as using Field-Programmable Gate Arrays circuits, ASIC, CPU, GPU, NPU etc. in addition or as an alternative. For the purpose of this application, all such possibilities and alternatives will be referred to simply as the controller 101.

The memory 102 is configured to store data such as application data, settings and computer-readable instructions that when loaded into the controller 101 indicates how the user equipment 100 is to be controlled. The memory 102 may comprise several memory units or devices, but they will be perceived as being part of the same overall memory 102. There may be one memory unit for a display arrangement storing instructions and application data, one memory unit for a display arrangement storing graphics data, one memory for the communications interface 103 for storing settings, and so on. As a skilled person would understand there are many possibilities of how to select where data should be stored and a general memory 102 for the user equipment 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

In one embodiment the user equipment 100 may further comprise a communication interface 103. The communication interface 103 may be wired and/or wireless. The communication interface 103 may comprise several interfaces.

In one embodiment the communication interface 103 comprises a USB (Universal Serial Bus) interface. In one embodiment the communication interface 103 comprises a HDMI (High Definition Multimedia Interface) interface. In one embodiment the communication interface 103 comprises a Display Port interface. In one embodiment the communication interface 103 comprises an Ethernet interface. In one embodiment the communication interface 103 comprises a MIPI (Mobile Industry Processor Interface) interface. In one embodiment the communication interface comprises an analog interface, a CAN (Controller Area Network) bus interface, an I2C (Inter-Integrated Circuit) interface, or other interface.

In one embodiment the communication interface 103 comprises a radio frequency (RF) communications interface. In one such embodiment the communication interface 103 comprises a Bluetooth™ interface, a WiFi™ interface, a ZigBee™ interface, a Z-Wave™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communications interface such as a fifth generation (5G) cellular communication interface, an LTE (Long Term Evolution) interface, a GSM (Global Systéme Mobilé) interface and/or other interface commonly used for cellular communication. In one embodiment the communication interface 103 is configured to communicate using the UPnP (Universal Plug n Play) protocol. In one embodiment the communication interface 103 is configured to communicate using the DLNA (Digital Living Network Appliance) protocol.

In one embodiment, the communication interface 103 is configured to enable communication through more than one of the example technologies given above. The communication interface 103 may be configured to enable the user equipment 100 to communicate with other devices, such as other smartphones.

The user interface 104 comprises one or more output devices and one or more input devices. Examples of output devices are a display arrangement, such as a display 104-1, one or more lights (not shown in FIG. 1A) and a speaker (not shown). Examples of input devices are one or more buttons 104-2, a camera (not shown) and a microphone (not shown). In one embodiment, the display arrangement comprises a display 104-1 that act both as an output and as an input device being able to both present graphic data and receive input through touch, for example through virtual buttons.

The user interface 104 of a user equipment 100 according to the teachings herein further comprises one or more side sensors 104-3 that are configured to detect and determine the presence of and distance to an object remotely, without contact being made. Such side sensors 104-3 (104-3A, 104-3B) enable for an extended user interface area 104-4 where touchless input may be provided. In the example of FIG. 1A there are two side sensors 104-3A and 104-3B arranged in the user equipment, one on either side of the display 104-1.

FIG. 1B shows a schematic view of components of a user equipment 100 such as the user equipment 100 of FIG. 1A, however in the example of FIG. 1B there are four side sensors 104-3A-D arranged, one on each side of the display 104-1, thereby providing an extended user interface 104-4 having four subsections 104-4A-D.

It should be noted that a side sensor 104-3 may comprise one sensor or an array of sensors depending on the technology being used for implementing such a side sensor. Examples of technologies for implementing such side sensors are: proximity sensors based on radar, light, capacitance, ultrasound, video to mention a few examples.

Utilizing such a side sensor 104-4, the user equipment 100 according to the teachings herein is enabled to determine that an object, such as a user's finger F, is at a distance D from a location L relative the display 104-1 as shown in FIG. 1B.

For the purpose of the teachings herein, all sensors will be treated as one sensor 104-3 providing an extended user interface area for touchless input, hereafter referred to as a touchless input area 104-4.

In an embodiment where the display 104-1 is a touch screen, the combination of a touch screen and the side sensor 104-3 thus provides for a combined interface area having one portion for touch input (the display 104-1) and one portion for touchless input (the touchless input area 104-4).

In one embodiment the touchless input area 104-4 is assigned to applications or processes that are executing as background applications. As is known a user equipment is able to execute an application in an active mode or in a background mode. An application being executed in an active mode, is assigned at least a portion of the display for providing graphical output and most of the buttons 104-2 of the user equipment 100, including any virtual buttons being displayed on the display 104-1 if the display 104-1 is a touch screen. An application being executed in a background mode, however, is not assigned more than a fraction of the display space and normally no controls at all. Controlling such a background application thus often requires that the background application is activated and made into an active application, whereby any other application being executed as an active application will have to be paused, as has been discussed above in the background section.

However, the user equipment 100 according to the present teachings is configured to receive input regarding background applications through the touchless input area 104-4. As stated above, the side sensor 104-3 is able to determine the distance D to an object F. It is thus possible to determine an activation of a command, such as a (touchless) press by determining that the distance D to an object falls under a threshold distance. Furthermore, also as stated above, the side sensor 104-3 is able to determine the Location L of an object F. It is thus possible to assign different commands or controls to different locations along the display 104-1. In this manner, the user interface 104 is expanded and allows for providing more user controls without obscuring or interfering with the display 104-1 space assigned to an active application.

FIG. 1C shows the user equipment 100 of FIG. 1A, where different commands have been assigned to different portions of the touchless input area 104-4. In this example there are three commands C1-C3 that are assigned to each a portion P1-P3 of the touchless input area 104-4. By the user equipment 100 determining within which portion P1-P3 the object being detected as being at a distance falling under the threshold distance, it is possible to determine which command C1-C3 to execute. In one embodiment the different commands C1-C3 relate to the same application. In one embodiment there is at least one command associated with a first application and at least one command associated with a second application. In one such embodiment, where there is a first and a second application, the first application is associated with a first portion of the touchless input area 104-4 and the second application is associated with a second portion of the touchless input area 104-4, wherein the commands associated with each application is assigned to a sub-portion of the portion of the corresponding application. For example, in the example of FIG. 1C, the first application is assigned portions P1 and P2, and the commands C1 and C2 are associated with the first application and the second application is assigned portion P3 and the command C3 is associated with the second application.

It should be noted that the size of the portions as well as location and/or distribution of portions need not be equal or regular, and any distribution is possible.

In order to provide an intuitive and easy to remember user interface that is simple to use, the user equipment 100 according to the teachings herein is configured to enable a user to setup the touchless input area 104-4.

FIG. 2A shows a schematic view of a user equipment 100 as in FIG. 1A, where one or more icons 110 are displayed on the display 104-1. Each icon 110 is associated with an application (or a function) as is commonly known, an icon thus being a graphic representation of the corresponding application or function.

A user wishing to select an application for assigning (at least some of) the controls of that application to the touchless input area 104-4 selects the corresponding icon 110-1 and drags it to the intended portion of the touchless input area 104-4, see FIG. 2B showing a schematic view of the user equipment 100 of FIG. 2A, where an icon 110-1 has been selected and is dragged towards one side of the display 104-1 (in this example the right side of the display 104-1 as being viewed in the figure).

The controller 101 of the user equipment 100 is thus configured to receive a selection of an application (through the selection of the application's graphical representation 110), determine that the graphical representation is dragged to a portion 104-1A of the display 104-1, and determine that the application is to be associated with a portion of the touchless input area 104-4 corresponding to the portion of the display 104-1. The side of the display 104-1 is in this example a portion 104-1A of the display 104-1 that is associated with a corresponding portion 104-4B of the touchless input area 104-4.

In response to the association, the controller 101 provides feedback indicting that the association of application and portion has been made. In one embodiment, the feedback is provided through visual feedback, such as by highlighting, changing the color and/or otherwise marking the portion 104-1A of the display 104-1 corresponding to the associated portion 104-4B of the touchless area 104-4. In FIG. 2B this is shown as a highlighting of the right side of the display 104-1.

As the association is made, the selected icon 110-1 is returned to its place, as is shown in FIG. 2C showing a schematic view of the user equipment 100 of FIG. 2A and FIG. 2B, where the icon 110-1 is returned to its original place.

In one embodiment, the feedback may also be to highlight, change color, frame and/or otherwise mark the selected icon 110-1 as is shown in FIG. 2C.

In one embodiment, the feedback may be temporary. In one such embodiment feedback is provided when the association is made. In an alternative or additional such embodiment feedback is provided when an object is detected in the corresponding portion of the touchless input area 104-4.

In one embodiment, the feedback is provided as long as the association is active.

In one embodiment the feedback provided for indicating the icon 110-1 is of a same type as the feedback provided for indicating the associated portion.

As discussed in the above, a first application (herein represented by its graphical representation, the icon) 110-1 may be associated with a first portion P1 of the touchless input area 104-4, and a second application (herein represented by its graphical representation, the icon) 110-2 may be associated with a second portion P2 of the touchless input area 104-4. This is also true for sub-portions of portions. This is shown in FIG. 2D.

The user equipment 100 according to herein is thus enabled to enable a user to assign or associate a first application with a first subportion P1 and assign or associate a second application with a second subportion P2 of the same side of a display 104-1.

In order to select which subportion of a portion (the side of the display being a portion in this example) an application is to be associated with, the controller is further configured to determine which subportion of the display 104-1 that the selected icon is dragged to, i.e. which portion of the side that the selected icon is dragged to.

FIG. 2D shows an example of the user equipment 100 of FIGS. 1A, 1B, 1C, 2A, 2B and 2C herein where four icons are displayed, each associated with an application (or other function) 110-1-110-4. There is also shown two subportions P1, P2 of the right side of the display 104-1. a user selects one application and associates it with a subportion by dragging the icon 110-1 of the application to the portion. In this example the first icon 110-1 is dragged to the first portion P1. Subsequently, the first application (being represented by the first icon 110-1) is associated with the first subportion P1 of the right side of the display 104-1. In one embodiment feedback is provided as is shown in FIG. 2E showing an example of the user equipment 100 of FIG. 2D where feedback is provided as highlighting of the first subportion P1 and framing of the first icon 110-1. FIG. 2E also shows how the second icon 110-2 is dragged to the second subportion P2, thereby associating the second application (being represented by the second icon 110-2) with the second subportion P2 of the right side of the display 104-1. In one embodiment feedback is provided as is shown in FIG. 2F showing an example of the user equipment 100 of FIG. 2E where feedback is provided as highlighting of the second subportion P2 and framing of the second icon 110-2. As can be seen in the example of FIG. 2F, the feedback given for the association of the first application and first portion is of a similar (first) type and the feedback given for the association of the second application and second portion is of a similar (second) type, where the first feedback type is different from the second feedback type, enabling a user to easily determine which portion is associated with which application.

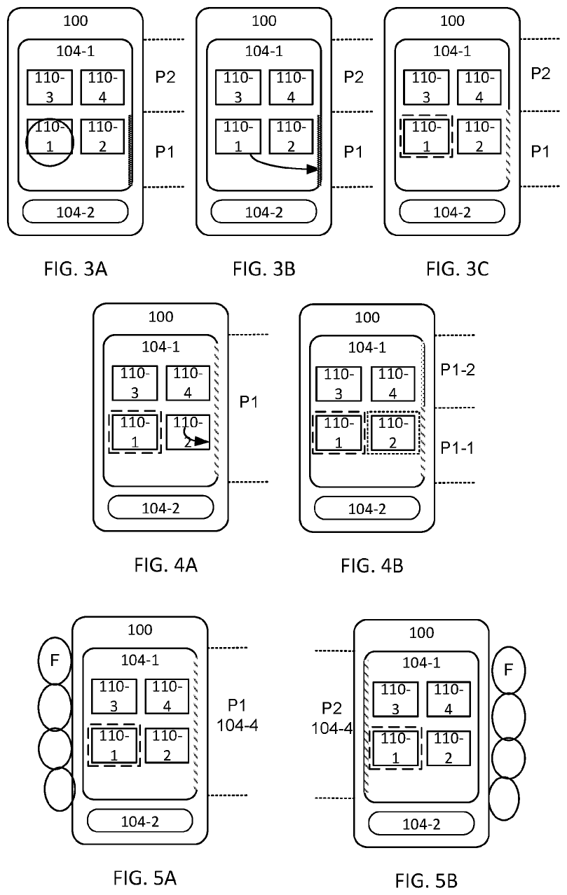

FIG. 3A shows a schematic view of a user equipment 100 as in any of FIG. 1A to 1C or 2A-2F, where the user equipment is further enabled to indicate to a user which (sub)portions are available, as in not having been associated to an application yet. In the example of FIG. 3A there are four icons 110-1-110-4 being displayed. As a selection of an icon is detected or received, the controller is in one embodiment to indicate any available (sub)portions. This is done visually in one embodiment, for example by highlighting the available portions. In FIG. 3A the selection of the first icon 110-1 is indicated by the circle representing the touch of a user on that icon 110-1. In this example, the first portion P1 is highlighted as being available. The feedback for indicating available (sub)portions is in one embodiment of a different type (a third type) than the feedback given for indicating an association. FIG. 3B shows a schematic view of the user equipment 100 of FIG. 3A where the selected icon 110-1 is dragged to the portion P1 indicated as being available, whereby an association is made. FIG. 3C shows a schematic view of the user equipment 100 of FIG. 3B where feedback indicating the association is provided.

In one embodiment the controller 101 is configured to determine that an icon is being dragged to a (sub)portion that is already associated with an application. In such a case, the controller may be configured to handle this in different ways.

In one embodiment, the controller 101 is configured to refuse the association until the icon is dragged to an available (sub)portion. Feedback may be given to indicate such refusal, for example through a visual indication and/or an audio output.

In one embodiment, the controller 101 is configured to accept the association and associate the (sub)portion to the application. In one such embodiment, the controller 101 is configured to cancel the previous association. Feedback may be given to indicate such replacement, for example through a visual indication. In an alternative or additional such embodiment, the controller 101 is configured to associate the previously associated application to another, available, (sub)portion. The already associated third application is thus associated with a third (sub)portion. Feedback may be given to indicate such replacement, for example through a visual indication. If no (sub)portion is available the embodiment where the previous association is cancelled may be used.

In an alternative or additional embodiment, the controller 101 is configured to determine that the selected (sub)portion is not available, and in response thereto divide the (sub)portion into two portions and associate the two portions to the previously associated application(s) and the application selected to be associated respectively. In one embodiment the controller 101 is configured to do so if it is determined that there are no available (sub)portions.

In all embodiments suitable feedback may be provided.

FIG. 4A shows a schematic view of a user equipment 100 as in any of FIG. 1A to 1C, 2A-2F, or 3A-3C where the user equipment 100 is further enabled to divide a portion into subportions if a user wishes to associate a second application to a portion P1 already associated with a first application. FIG. 4A shows how the first icon 110-1 is indicated to be associated with the first portion P1. FIG. 4A also shows how the second icon 110-2 is selected and dragged onto the same portion P1. The controller detects this and divides the portion into two subportions, P1-1 and P1-2 respectively and associates the previously associated first application 110-1 with the first subportion P1-1 and the second application 110-2 selected to be associated with the second subportion P1-2. FIG. 4B shows the user equipment of FIG. 4A, where the associations have been made and feedback is provided to indicate that the first application 110-1 is associated with the first subportion P1-1 and the second application 110-2 is associated with the second subportion P1-2.

As the inventors have further realized there may be problems when a user is holding the user equipment 100 differently than first intended. The inventors have therefore devised a manner in which the portions are moved (or rather re-associated) depending on where the user is holding or touching (a side of) the user equipment 100.

FIG. 5A shows a schematic view of a user equipment 100 as in any of FIG. 1A to 1C, 2A-2F, 3A-3C, or 4A-4B where the user equipment 100 is further enabled to determine that a user's touch or hold is altered. In FIG. 5A one hold is detected, indicated by a user's fingers F on one side of the user equipment 100. As can be seen a portion P1 of the touchless input area 104-4 is arranged on the opposite side of the user equipment 100. FIG. 5B shows the user equipment 100 of FIG. 5A where the hold has been changed, as is indicated by the user's fingers F now being shown on the other side of the user equipment 100, now potentially blocking or interfering with the touchless input area 104-4. The controller 101 is, however in one embodiment, configured to detect that a hold has been changed and in response thereto re-associate the portions and their associated applications. This is done in one embodiment by determining any portion that has an overlap with the new hold, i.e. if there are any fingers or such grasping the user equipment 100 in a location corresponding to a portion P1, and re-associate the application associated with such an overlapped portion with an available portion. The controller 101 is also configured to determine that previously overlapped portions are no longer overlapped by detecting the removal or absence of previously detected objects in that portion. As seen in FIG. 5B, the fingers have moved and released portion P2, previously blocked, and the application 110-1 previously associated with portion P1, which is now blocked, have now been re-associated with the second portion P2. In this example, the user has changed hand and the controller has consequently mirrored the associations.

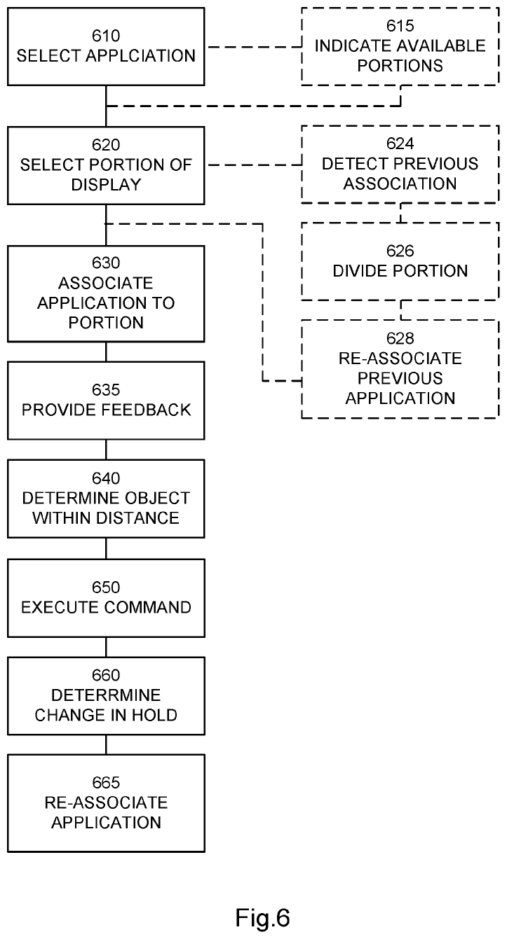

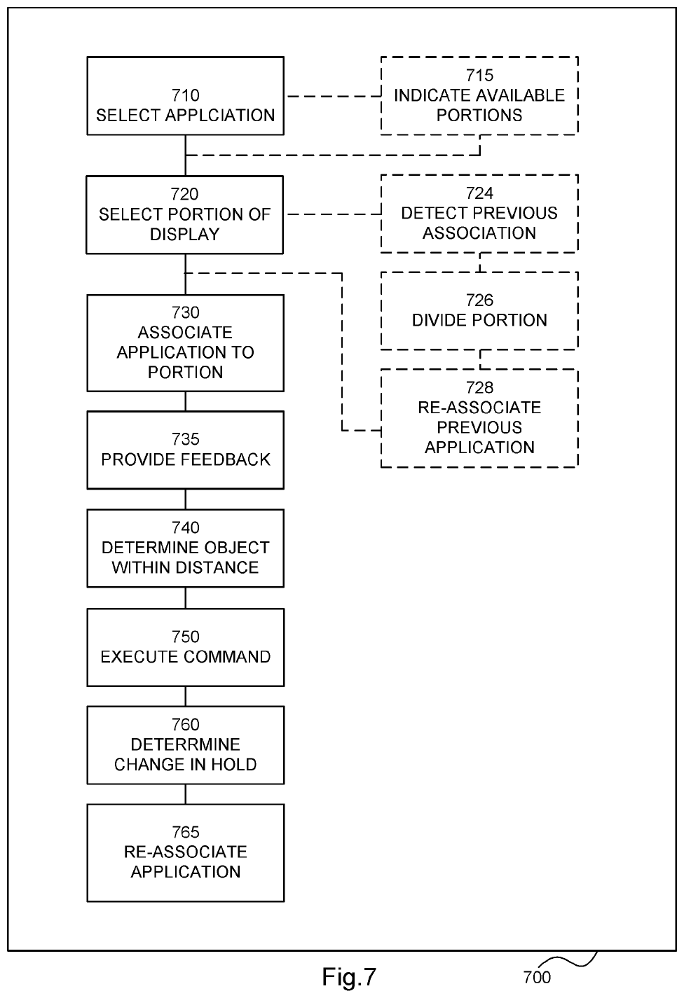

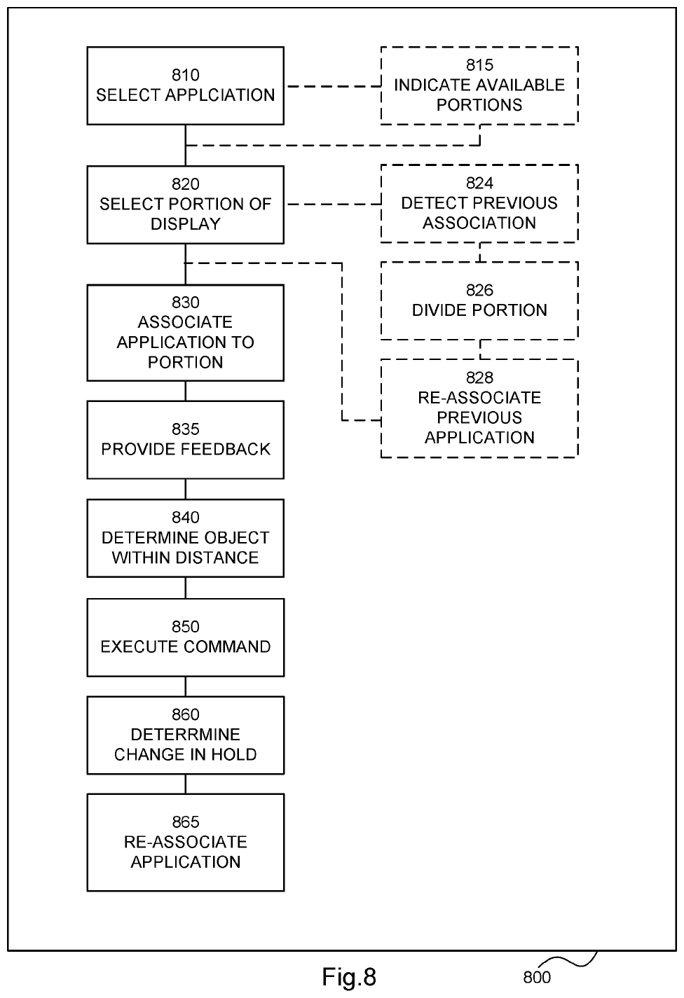

FIG. 6 shows a flowchart for a general method according to herein. The controller 101 receives 610 a selection of an application through receiving a selection of a graphical representation, for example an icon 110, of that application. The controller 101 then receives 620 a selection of a portion 104-4A-D of the touchless input area 104-4 by determining that the selected application is dragged to a portion of the display 104-1 corresponding to the portion 104-4A-D of the touchless input area 104-4.

In one embodiment, a portion 104-4A-D of the touchless input area 104-4 corresponds to a side of the display 104-1. In one embodiment, the portion 104-4A-D of the touchless input area 104-4 corresponds to a portion of a side of the display 104-1.

In response to associating an application to a portion, the controller 101 assigns or associates 630 at least one command for the selected application to the selected portion 104-4A-D of the touchless input area 104-4. In one embodiment a plurality of commands is associated to the portion, each command being associated to each a subportion.

In one such embodiment the controller 101 is further configured to indicate 615 which portions are available for association with an application. In one alternative or additional embodiment, the controller 101 is further configured to determine that the selected portion is associated 624 with another application, i.e. to detect a previous association for that portion, and in response thereto re-associate 628 the other application with another (available) portion as well as associate the portion with the selected application 630 as will be noted below. In one alternative or additional embodiment, the controller 101 is further configured to determine that the selected portion is associated 624 with another application and in response thereto divide 626 the selected portion into (at least) two subportions and re-associate 628 the other application with one of the subportions of the selected portion as well as associate the other subportion of the selected portion with the selected application 630 as will be noted below.

The controller 101 provides 635 feedback indication the association between the portion and the application.

Any determination 640 of an object being at a distance D falling under a threshold distance in the selected portion is thereafter determined as being a user input selecting to execute the associated command, and the controller 101 therefore executes 650 the command. In one embodiment, the controller 101 is further configured to determine that the detected object is a finger of a user. In one alternative or additional embodiment, the controller 101 is further configured to determine that the object F is of an extent that is smaller than the portion's extent.

In some embodiments, the controller 101 may be further configured to determine 660 that a hold of the user equipment 100 has been changed and in response there to re-associate 665 the applications to other portions. In one such example, the controller 101 is configured to determine that a portion is being blocked by a user's fingers (or other instrument) holding the user equipment, and in response thereto re-associate the application associated to the now blocked portion to another portion. In one such example the controller 101 is configured to determine that a hold of the user equipment 100 has been changed from one side to the other (lefthand-side to righthand-side or vice versa) and in response thereto re-associate applications and portions so that the associations are mirrored.

Other variants and alternatives area also possible for the various functions as discussed in the above. Some of these alternatives will be discussed below, and it should be noted that they may all, some or each be combined with the embodiments discussed in the above as suitable and compatible.

One group of such alternative functions relate to when there are controls arranged on the side of the user equipment 100, such as when the user equipment 100 comprises one or more buttons 104-2 arranged on the side of the display. In order to not create conflicts between touchless input in the touchless input area and touch input on the side controls, the controller is configured—in some embodiments—to treat portions of the touchless input area corresponding to locations of such side controls as unavailable portions. In one embodiment, such portions may be specifically marked when an application has been selected.

In some embodiments, to avoid unintentional actions performed in the touchless input area 104-4, the user equipment 100 could be triggered by a gesture, for example a double tap performed by the index finger on the hand holding the user equipment 100 after which the side sensors are enabled and can detect user input in the touchless input area 104-4 with the hand not holding the user equipment 100.

In another embodiment, to avoid unintentional actions performed in the touchless input area 104-4, the side sensors would start to interpret user input first after a period of time during which the hand not holding the device has been kept at the same point in the touchless input area 104-4.

It should be noted that for the purpose of the teachings herein there is made no difference between an application and the graphical representation of the application.

It should also be noted that for the purpose of the teachings herein there is made no difference between a portion of the touchless input area and the corresponding portion of the display, unless specifically indicated.

FIG. 7 shows a component view for a software module (or component) arrangement 700 according to an embodiment of the teachings herein. The software module arrangement 700 is adapted to be used in a user equipment 100 as taught herein and for enabling the user equipment 100 to execute a method according to FIG. 6. The a software module arrangement 700 comprises a software module for receiving 710 a selection of an application and a software module for receiving 720 a selection of a portion 104-4A-D, P1, P2 of the touchless input area 104-4. The a software module arrangement 700 also comprises a software module for associating 730 at least one command for the selected application to the selected portion 104-4A-D, P1, P2 of the touchless input area 104-4 and a software module for providing 735 feedback indication the association between the portion and the application. The a software module arrangement 700 also comprises a software module for determining 740 that an object F is at a distance D falling under a threshold distance in the selected portion 104-4A-D, P1, P2 of the touchless input area 104-4 and a software module for executing 750 the associated command in response thereto.

FIG. 8 shows a component view for an arrangement 800 comprising circuitry. The arrangement comprising circuitry is adapted to be used in a user equipment 100 as taught herein and for enabling the user equipment 100 to execute a method according to FIG. 6. The arrangement 800 comprises circuitry for receiving 810 a selection of an application and circuitry for receiving 820 a selection of a portion 104-4A-D, P1, P2 of the touchless input area 104-4. The arrangement 800 also comprises circuitry for associating 830 at least one command for the selected application to the selected portion 104-4A-D, P1, P2 of the touchless input area 104-4 and circuitry for providing 835 feedback indication the association between the portion and the application. The arrangement 800 also comprises circuitry for determining 840 that an object F is at a distance D falling under a threshold distance in the selected portion 104-4A-D, P1, P2 of the touchless input area 104-4 and circuitry for executing 850 the associated command in response thereto.

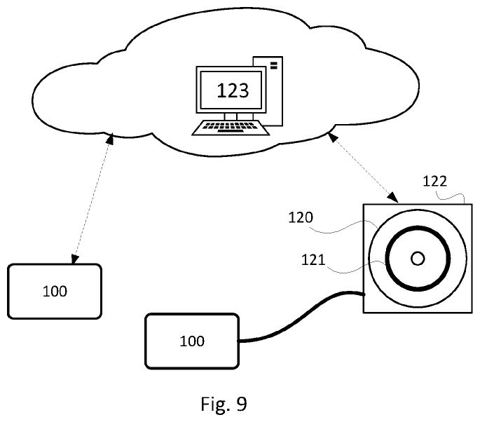

FIG. 9 shows a schematic view of a computer-readable medium 120 carrying computer instructions 121 that when loaded into and executed by a controller 101 of a user equipment 100 enables the user equipment 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 9, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the user equipment 100 for being executed by the controller 101.

The computer disc reader 122 may also or alternatively be connected to (or possibly inserted into) a user equipment 100 for transferring the computer-readable computer instructions 121 to a controller 101 of the user equipment 100 (presumably via a memory 102 of the user equipment 100).

FIG. 9 shows both the situation when a user equipment 100 receives the computer-readable computer instructions 121 via a server connection and the situation when another user equipment 100 receives the computer-readable computer instructions 121 through a wired interface. This enables for computer-readable computer instructions 121 being downloaded into a user equipment 100 thereby enabling the user equipment 100 to operate according to and implement the invention as disclosed herein.

1. A user equipment comprising a display, at least one side sensor and a controller,
wherein the side sensor is configured to receive touchless user input at a side of the display, thereby providing a touchless input area, and wherein the controller is configured to:
receive a selection of an application;
receive a selection of a portion of the touchless input area;
associate at least one command for the selected application to the selected portion of the touchless input area;
provide feedback indication the association between the portion and the application;
determine that an object is at a distance falling under a threshold distance in the selected portion of the touchless input area and in response thereto execute the associated command.

2. The user equipment according to claim 1, wherein the controller is further configured to receive the selection of the application by receiving a selection of a graphical representation of the application.

3. The user equipment according to claim 1, wherein the controller is further configured to receive the selection of a portion of the touchless input area by determining that the selected application is dragged to a portion of the display corresponding to the portion of the touchless input area.

4. The user equipment according to claim 1, wherein the portion of the touchless input area corresponds to a side of the display.

5. The user equipment according to claim 4, wherein the portion of the touchless input area corresponds to a portion of a side of the display.

6. The user equipment according to claim 1, wherein a plurality of commands is associated to the portion, each command being associated to each a subportion.

7. The user equipment according to claim 1, wherein the controller is further configured to indicate at least one portion available for association with an application.

8. The user equipment according to claim 1, wherein the controller is further configured to determine that the selected portion is associated with another application and in response thereto re-associate the other application with another portion

9. The user equipment according to claim 1, wherein the controller is further configured to determine that the selected portion is associated with another application and in response thereto divide the selected portion into at least two subportions and re-associate the other application with one of the subportions of the selected portion as well as associate the other subportion of the selected portion with the selected application.

10. The user equipment according to claim 1, wherein the controller is further configured to determine that a hold of the user equipment has been changed and in response there to re-associate the application to another portion.

11. The user equipment according to claim 1, wherein the selected application is a background application.

12. The user equipment according to claim 1, wherein the user equipment is a smartphone, smart watch or a tablet computer.

13. A method for use in a user equipment comprising a display and at least one side sensor configured to receive touchless user input at a side of the display, thereby providing a touchless input area, and
wherein the method comprises:
receiving a selection of an application;
receiving a selection of a portion of the touchless input area;
associating at least one command for the selected application to the selected portion of the touchless input area;
providing feedback indication the association between the portion and the application;
determining that an object is at a distance falling under a threshold distance in the selected portion of the touchless input area; and
in response thereto executing the associated command.

14. A non-transitory computer-readable medium carrying computer instructions that when loaded into and executed by a controller of a user equipment enables the user equipment to implement a method for use in the user equipment, wherein the user equipment comprises a display and at least one side sensor configured to receive touchless user input at a side of the display, thereby providing a touchless input area, and wherein the method comprises:
receiving a selection of an application;
receiving a selection of a portion of the touchless input area;
associating at least one command for the selected application to the selected portion of the touchless input area;
providing feedback indication the association between the portion and the application;
determining that an object is at a distance falling under a threshold distance in the selected portion of the touchless input area and
in response thereto executing the associated command.

15. (canceled)

16. An arrangement adapted to be used in a user equipment comprising a display, at least one side sensor configured to receive touchless user input at a side of the display, thereby providing a touchless input area, and said arrangement comprising:
circuitry for receiving a selection of an application;
circuitry for receiving a selection of a portion of the touchless input area;
circuitry for associating at least one command for the selected application to the selected portion of the touchless input area;
circuitry for providing feedback indication the association between the portion and the application;
circuitry for determining that an object is at a distance falling under a threshold distance in the selected portion of the touchless input area; and
circuitry for executing the associated command in response thereto.
